(19) United States
(12) Patent Application Publication
(10) Pub. No.: US 2004/0186884 A1
(43) Pub. Date: Sep. 23, 2004

(54) Automatic receipt confirmation system for electronic mail

(76) Inventor: Christophe Dutordoir, Brussels (BE)

Correspondence Address: ARMSTRONG, WESTERMAN & HATTORI, LLP, Suite 220, 502 Washington Avenue, Towson, MD, 21204, US

(21) Appl. No.: 10/391,041

(22) Filed: Mar. 17, 2003

(51) Int. Cl. G06F 15/16

(52) U.S. Cl. 709/206

(57) ABSTRACT

The invention consists in inserting a code in an appropriate e-mail message type to automatically generate a request over a communication network as soon as the message is displayed by its recipient. The request consists in recalling a uniquely named file, or a page (URL) whose parameter is a unique code on a certain server. This file name or unique code corresponds to a previously created record. Then, the system may select this record and send its issuer a notice that the corresponding message was actually displayed by the recipient.

### TECHNICAL FIELD

This invention relates to an automatic e-mail receipt notice system, to be used both in the Internet and in intranets, VPNs (Virtual Private Networks) or local networks.

1. Description of the Problem

At present, when an e-mail message is sent over the Internet, no notice is automatically posted to confirm that this message has been actually read by its recipient.

2. Description of Prior Art

In the latest version of its e-mail client (Outlook Express 5), Microsoft offers a new <<read receipt request>> feature. This feature simply informs the recipient that the sender would like to receive a read receipt, and proposes him a receipt sending confirmation dialog (Yes/No).

If the recipient accepts, a confirmation message is sent to the sender. If he refuses, nothing will happen. Hence, the recipient is not obliged to return a receipt. He/she may even select the option of never displaying these receipt requests, in the software options.

WO01444953 and WO00110090 propose a system for automatically generating an e-mail receipt as soon as an e-mail message is read. These systems are based on the fact that an e-mail message is sent over a specific server belonging to a trusted provider. According to these documents, the electronic message must be sent over a target system, wherein specific software is installed which detects the e-mails and sends receipts.

No other system exists, to the applicant's best knowledge, which provides a practical solution to the above described problem.

### OBJECT OF THE INVENTION

This invention proposes an automatic system for confirming the receipt of e-mail messages sent to any recipient, which system does not depend on the e-mail server used by the sender or the recipient. The receipt notice is sent with no recipient intervention.

### SUMMARY OF THE INVENTION

The invention consists in inserting a code in an appropriate e-mail message type to automatically generate a request over a communication network as soon as the message is displayed by its recipient. This request consists in recalling a uniquely named file, or a page (URL) whose parameter is a unique code over a certain server. This unique file name or code corresponds to a previously created record, whereby the system may select this record and send its issuer the confirmation that the corresponding message was actually displayed by the recipient. This constitutes a receipt notice.

### DETAILED DESCRIPTION OF THE INVENTION

The invention is described hereafter in greater detail with reference to the accompanying drawings, which are provided without limitation, and in which

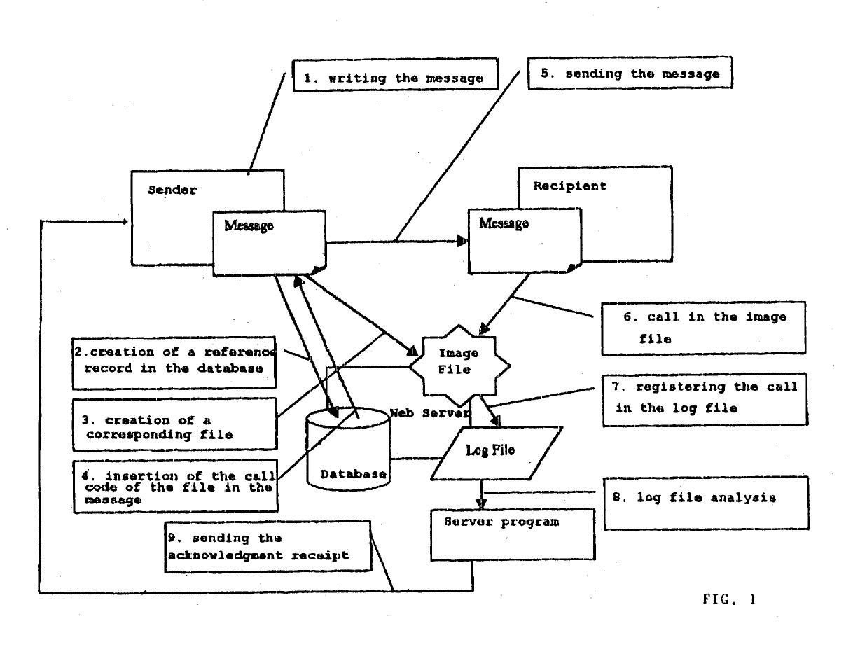

FIG. 1 is a diagram which schematically shows a first embodiment of the invention.

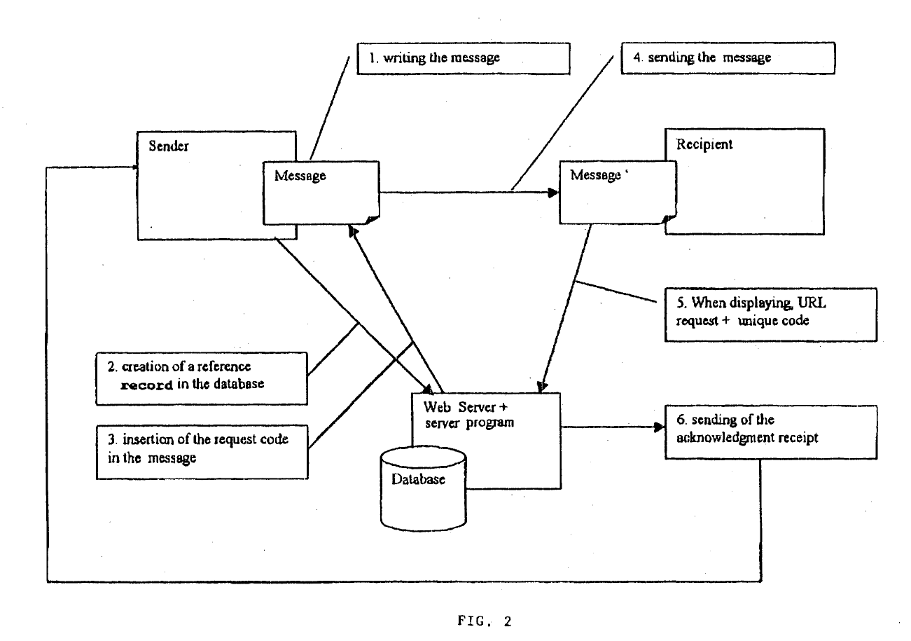

FIG. 2 is a diagram which schematically shows a second embodiment.

In accordance with a first embodiment, the invention first consists in inserting a recall to a file situated on a Web server in an electronic message.

Once the message is read—or displayed—by the recipient, this file is automatically recalled in a well-known manner, whereby a record is generated in the server log file.

Bu further selecting the log file, it is possible to learn whether the message has been read, or anyway displayed.

Further, it will be understood that if the file—typically an image file, possibly transparent—is created with a specific name on the server, and referenced as such in the electronic message, this will constitute a sort of receipt notice.

The solution may be used exactly as described above. However, in order to make it accessible to a wider public, it shall be complemented by a client/server software solution.

FIG. 1 shows an example of implementation of the inventive system.

Hence the server system will manage different features

creating the user account on the server,

managing payments for the use of such receipt notice service,

creating files to be recalled by the e-mail message on the server—including name creation algorithms,

inserting the recall to these files in messages,

creating a record in a database, allowing to determine the correspondence between the file recall in the log file and the reference to the actual message (sender data, message reference, send data, etc.)

analyzing the log file,

posting a confirmation e-mail to the sender—or providing this information by any means whatever (e.g. by secure access to the database through on-line consultation interfaces),

possibly managing the expiration of receipt requests, the cancellation thereof, etc.

Technical Implementation

The technical implementation of the first level solution may be illustrated by the following example:

Internet server http://www.e-mail-receipt.net/

Image file creation

XXYYZZZ123456.gif (e.g. 1 pixel transparent image file, with gif extension)

HTML code to be inserted in the electronic message <img src=http://www.e-mail-receipt.net/Custlmages/XXYYZZZ123456.gif>

The server domain name “e-mail-receipt.net” is obviously provided as an example.

According to a second embodiment, an advantageous simplification of the system is proposed, which is shown in FIG. 2. It shall be noted that, in this figure, the steps 1, 2 and 3 may be reversed. In this case, the message is created immediately before step 3, instead of step 1.

The simplification consists in inserting, in the HTML tag <IMG>, instead of a reference to an image file, the address of a page (URL) whose parameter is a unique code. This code corresponds to a previously created record, whereby the system may select this record and send its issuer the confirmation that the corresponding message was actually viewed by the recipient.

This allows to avoid the log file analysis part. Therefore, the receipt sending process is immediate.

The solution may be used exactly as described above. However, in order to make it accessible to a wider public, it shall once more be complemented by a client/server software solution.

Hence, a site, e.g. http://e-mail-receipt.net may be created to implement the invention. This site allows a user connected to a network, e.g. the Internet, who subscribes to the service (as a client) to:

Create his/her own user account,

Access a secure part of the site,

Make the payments required to credit his/her client account,

Manage his/her profile (first name, second name, password, e-mail address, defaults, etc.),

Create new receipt notices (by entering the subject/reference, expiration date, maximum number of receipts to be sent via e-mail, receipt visible by the recipient Yes/No, etc.) and obtain the code to be inserted in the message.

Consult and change his/her pending receipts,

Review the history of his/her acknowledgements, and change them,

Store his/her acknowledgements (have them sent via e-mail and clear them from the server).

Insertion of the Code in the Electronic Message

As shown above, in the secure part of the Web site, the system user may create his/her own receipts. Particularly, he/she may enter the desired subject/reference of the receipt he/she will receive via e-mail. He/she may also change default settings, e.g. the receipt time-out, the maximum number of e-mail messages to be sent, etc.

When the user submits this form, a page appears which contains a code to be inserted in his/her message.

E.g. <img src=“http://e-mail-receipt.net/Confirm.cfm?id=XXYYZZZ123456”>

The user may easily copy the code and paste it in message source code (if the client software allows to do so), or use the option “Insert image” and paste therein the URL of the request (e.g.: http//e-mail-receipt.net/Confirm.cfm?id=XXYYZZZ123456)

Technical Implementation

### EXAMPLES

The user enters the following instruction in a HTML electronic message

<img src=“http://www.e-mail-receipt.net/confirm.cfm?id=XXYYZZZ123456”>or

<img src-“http://www.e-mail-receipt.net/Receipt.asp?key=XXYYZZZ123456”>

In the first example, the user simply needs to create a record containing a unique number (ID), the sender reference and the subject, and insert the code in the e-mail message to be sent.

When the e-mail message is opened, the tag will be interpreted by the e-mail client of the recipient and the page will be recalled on the server. The software will simply have to search for the record that is referenced in the page recall (ID=XXYYZZZ123456) and to give the sender referenced therein, a confirmation that his/her e-mail message has been actually opened.

Advantages of the Inventive Solution

The main advantage of the solution proposed by the invention is that the read receipt is transmitted automatically, with no recipient intervention. An additional advantage is that the confirmation process is started by the sender, who can obviate the problem that the recipient might be unwilling to confirm receipt.

It shall be noted that the system proposed by the invention does not affect privacy more than prior art solutions, as the information provided is already recorded in the log file of e-mail servers. This means that there is already a third party who is able to access this information (generally the mail ISP, for private mail, and the EDP department or manager, for professional mail).

In fact, the information on the receipt delivering server is almost totally confidential, both for the sender and the recipient. The information known by the server only consists of a reference, a read date and time and an IP address. The e-mail address of the recipient is not required for proper process execution. The message content will not even transit through it.

It shall be understood that the server database, possibly selectively accessible to the sender-client, may count the number of times that the electronic message has been opened by the recipient.

The sender may enter a maximum number of receipts to be accounted on the server for a predetermined message. The server bill may depend on the number of transmitted receipts.

It shall be also understood that, if the recipient opens the message offline and cancels the automatic connection attempt, the receipt request will not be sent over the network.

Users-recipients may advantageously install a program allowing to delay the request transmission until the next connection to the network.

It shall be noted that one aspect of the invention proposes to insert a recall to a page or script, in lieu of an image file, in an HTMP <IMG> tag. For instance, this tag might be: This novel aspect may be implemented independently of the automatic receipt notice system of this invention.

1. An automatic e-mail receipt notice managing system, characterized in that a code is inserted by the sender in an electronic message, to automatically generate a request as soon as said message is displayed by the recipient, which request has characteristics corresponding to a record that was previously created or introduced in a database provided on a server, wherefrom an application may select this record and post or otherwise provide the confirmation that the message has been displayed by the recipient to the sender.

2. A system as claimed in claim 1, wherein the insertion is effected by the sender either manually or through a client application or an on-line executable program on said server or another one.

3. A managing system as claimed in claim 1 or 2, characterized in that an instruction is inserted to recall a uniquely named file situated on an Internet server,
the recalling instruction and the specific file name being inserted in a well-known manner in the electronic message, before sending it, by the computer of said sender,
said recalling instruction being automatically executed in a well-known manner as soon as said electronic message is displayed by the recipient,
the recall of this file generating a record in the log file of said server,
said record being automatically communicated or accessible to the sender of the message, as a receipt notice.

4. A system as claimed in any preceding claim, characterized in that the e-mail message is in HTML or XML format.

5. An e-mail managing system as claimed in claim 1 or 2, characterized in that the record characteristics are contained in a HTML <IMG> tag, or equivalent, which includes a page address (URL) and a parameter.

6. A system as claimed in claim 5, wherein the parameter is provided as a unique code, allowing to identify the record of the corresponding receipt notice.

7. A method of sending e-mail with an automatic receipt, characterized in that a tag is inserted by the sender in an electronic message, which tag contains an instruction to recall an Internet server selected by the sender, said instruction being automatically executed every time the e-mail is opened by the recipient, the characteristics of the instruction having been determined by (or communicated to) the computer of said server, which automatically sends a receipt to the sender as soon as at least a first recalling instruction corresponding to said characteristics is received.

8. Use of an HTML <IMG> tag to recall a page or a script.
